(19) United States
(12) Patent Application Publication
(10) Pub. No.: US 2007/0173572 A1
(43) Pub. Date: Jul. 26, 2007

(54) Flame retardant resin composition

(75) Inventors: Gaurav Mediratta, Bangalore (IN); Subodh Kumar Pal, Bangalore (IN); Reema Sinha, Bangalore (IN); Srinivason Krishnaswami, Bangalore (IN); Gomatam Raghavan Ravi, Bangalore (IN); Chris van der Weele, Sommelsdijk (NL); Rama Konduri, Evansville, IN (US); Kenneth Frederick Miller, Mt. Vernon, IN (US)

Correspondence Address: GEAM - O8CV - CPP;IP LEGAL, ONE PLASTICS AVENUE, PITTSFIELD, MA, 01201-3697, US

(73) Assignee: General Electric Company

(21) Appl. No.: 11/336,503

(22) Filed: Jan. 20, 2006

(51) Int. Cl. C08K 5/49

(52) U.S. Cl. 524/115

(57) ABSTRACT

A flame retardant resin composition comprising a polyester, a flame retardant compound, wherein said flame retardant compound comprises at least one P—H bond; an organic compound wherein said organic compound comprises of at least one carboxyl reactive group; and a phosphine suppressing additive compound. The composition possesses good stability and mechanical property. Also disclosed is a process to prepare these compositions and articles therefrom.

### BACKGROUND OF THE INVENTION

This invention relates to flame retardant polyester compositions comprising phosphorus containing compounds, with significantly reduced phosphine gas emission and good flame retardant properties.

Many applications of engineering plastics require polymer compositions that have flame retardant properties along with properties such as good tensile strength, high heat deflection temperature (HDT) and chemical resistance. The flame retardant properties are achieved through incorporation of flame retarding (hereinafter also known as “FR”) agents in the formulations.

Halogen containing compounds are very effective as FR agents for polymeric materials. However due to concerns over potential environmental hazards of halogen containing FRs recycling of polymeric compositions containing this class of flame retardants is not desirable. Therefore, several attempts have been made to prepare halogen-free flame retardant polyester formulations.

It is known that polyesters can be made flame retardant by using halogen-free flame retardants based on phosphorous-containing compounds, in particular P—H bond containing compounds such as calcium hypophosphite and aluminum hypophosphite. However, one major disadvantage with this type of phosphorus containing FR agents lies in their tendency to generate phosphine at elevated temperatures at which the polymeric resins are processed. Phosphine is spontaneously flammable, highly toxic and a strong irritant. Phosphine emission is particularly higher if the processing temperature of the polymeric resins increases.

Various methods have been reported in literature for the minimization of phosphine generation owing to disproportionation reactions of red phosphorous as FR agent. U.S. Pat. Nos. 4,210,630 and 2,035,953 describe the precipitation of metal hydroxide upon red phosphorus which is used as an FR agent. Another attempt was employing phosphine traps such as cupric oxide as described in U.S. Pat. Nos. 3,883,475 and 4,187,207. U.S. Pat. No. 4,403,052 describes the reduction in the amount of phosphine generated by use of metal iodide as a suppressant for the phosphine when red phosphorous is used as a flame retardant. U.S. Pat. No. 4,255,319 describes a composition incorporating aldehydes, and beta-carbonyl containing ketones and red phosphorus as the FR. The U.S. Pat. No. 4,356,282 describes the use of cupric salts like chloride, acetates, cuprous acetate, cuprous chloride and the like as phosphine suppressants.

The U.S. Pat. No. 5,270,370, JP63191835 employ unsaturated compounds, some with an alpha double bond to an electron-withdrawing group, for minimizing phosphine emissions from red phosphorous. GB 1,424,523 teaches compositions that comprise red phosphorus coated with a liquid unsaturated compound that undergoes auto-oxidation in air to reduce the disadvantage of emissions. JP 1988-191835 talks about a polyester composition wherein the polyester has an unsaturation in the diol or the diacid part and a phosphorus containing FR additive.

U.S. Patent Application Ser. No. 20050137300 and U.S. Pat. No. 6,716,899 disclose polyester with phosphinates and other phosphorus compounds as FR additives along with epoxides as chain extenders and unsaturated elastomeric additives. The U.S. Pat. No. 6,538,054 describes a FR-PBT composition with calcium hypophosphite as the flame retardant and pentaerythritoltetrastearate and an unsaturated amide containing additive and optionally a fibrous filler with epoxy silane sizing. There is no information on the level of phosphine emission in these compositions.

There is a continuing need to provide a novel halogen-free flame retardant polyester material having improved long term thermal stability (RTI), processability, mechanical strength, and moldability properties while being significantly free from the risk of toxic gas emission such as phosphine during processing operations under normal or extreme conditions of time and temperature.

### BRIEF DESCRIPTION OF THE INVENTION

According to one embodiment of the present invention a flame retardant resin composition comprising a) a polyester, b) 0.1 weight percent to about 20 weight percent based on the total weight of the composition of a flame retardant compound, wherein said flame retardant compound comprises at least one P—H bond; c) 0.1 weight percent to about 5 weight percent based on the total weight of the composition an organic compound wherein said organic compound comprises of at least one carboxyl reactive group; and; d) 0.2 weight percent to about 20 weight percent based on the total weight of the composition of an phosphine suppressing additive compound; and wherein amount of phosphine suppression during processing or molding is greater than about 10% relative to a composition comprising polyester and component (b) or (c) of the combination is described.

In one embodiment of the present invention is disclosed the method of synthesizing the composition and articles derived from said composition.

Various other features, aspects, and advantages of the present invention will become more apparent with reference to the following description, examples, and appended claims.

### DETAILED DESCRIPTION OF THE INVENTION

The present invention may be understood more readily by reference to the following detailed description of preferred embodiments of the invention and the examples included herein. In this specification and in the claims which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

“Combination” as used herein includes mixtures, copolymers, reaction products, blends, composites, and the like.

As used herein the term “aliphatic radical” refers to a radical having a valence of at least one comprising a linear or branched array of atoms which is not cyclic. The array may include heteroatoms such as nitrogen, sulfur, silicon, selenium and oxygen or may be composed exclusively of carbon and hydrogen. Aliphatic radicals may be “substituted” or “unsubstituted”. A substituted aliphatic radical is defined as an aliphatic radical which comprises at least one substituent. A substituted aliphatic radical may comprise as many substituents as there are positions available on the aliphatic radical for substitution. Substituents which may be present on an aliphatic radical include but are not limited to halogen atoms such as fluorine, chlorine, bromine, and iodine. Substituted aliphatic radicals include trifluoromethyl, hexafluoroisopropylidene, chloromethyl; difluorovinylidene; trichloromethyl, bromoethyl, bromotrimethylene (e.g. —CH₂CHBrCH₂—), and the like. For convenience, the term “unsubstituted aliphatic radical” is defined herein to encompass, as part of the “linear or branched array of atoms which is not cyclic” comprising the unsubstituted aliphatic radical, a wide range of functional groups. Examples of unsubstituted aliphatic radicals include allyl, aminocarbonyl (i.e. —CONH₂—), carbonyl, dicyanoisopropylidene (i.e. —CH₂C(CN)₂CH₂—), methyl (i.e. —CH₃), methylene (i.e. —CH₂—), ethyl, ethylene, formyl, hexyl, hexamethylene, hydroxymethyl (i.e.—CH₂OH), mercaptomethyl (i.e. —CH₂SH), methylthio (i.e. —SCH₃), methylthiomethyl (i.e. —CH₂SCH₃), methoxy, methoxycarbonyl, nitromethyl (i.e. —CH₂NO₂), thiocarbonyl, trimethylsilyl, t-butyldimethylsilyl, trimethyoxysilypropyl, vinyl, vinylidene, and the like. Aliphatic radicals are defined to comprise at least one carbon atom. A C₁-C₁₀ aliphatic radical includes substituted aliphatic radicals and unsubstituted aliphatic radicals containing at least one but no more than 10 carbon atoms.

As used herein, the term “aromatic radical” refers to an array of atoms having a valence of at least one, comprising at least one aromatic group. The array of atoms having a valence of at least one, comprising of at least one aromatic group, may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n =2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. Aromatic radicals may be “substituted” or “unsubstituted”. A substituted aromatic radical is defined as an aromatic radical which comprises at least one substituent. A substituted aromatic radical may comprise as many substituents as there are positions available on the aromatic radical for substitution. Substituents which may be present on an aromatic radical include, but are not limited to halogen atoms such as fluorine, chlorine, bromine, and iodine. Substituted aromatic radicals include trifluoromethylphenyl, hexafluoroisopropylidenebis(4-phenyloxy) (i.e. —OPhC(CF₃)₂PhO—), chloromethylphenyl; 3-trifluorovinyl-2-thienyl; 3-trichloromethylphenyl (i.e. 3-CCl₃Ph—), bromopropylphenyl (i.e. BrCH₂CH₂CH₂Ph—), and the like. For convenience, the term “unsubstituted aromatic radical” is defined herein to encompass, as part of the “array of atoms having a valence of at least one comprising at least one aromatic group”, a wide range of functional groups. Examples of unsubstituted aromatic radicals include 4-allyloxyphenoxy, aminophenyl (i.e. H₂NPh—), aminocarbonylphenyl (i.e. NH₂COPh—), 4-benzoylphenyl, dicyanoisopropylidenebis(4-phenyloxy) (i.e. —OPhC(CN)₂PhO—), 3-methylphenyl, methylenebis(4-phenyloxy) (i.e. —OPhCH₂PhO—), ethylphenyl, phenylethenyl, 3-formyl-2-thienyl, 2-hexyl-5-furanyl; hexamethylene-1,6-bis(4-phenyloxy) (i.e. —OPh(CH₂)₆PhO-); 4-hydroxymethylphenyl (i.e. 4-HOCH₂Ph—), 4-mercaptomethylphemyl (i.e. 4-HSCH₂Ph—), 4-methylthiophenyl (i.e. 4-CH₃SPh—), methoxyphenyl, methoxycarbonylphenyloxy (e.g. methyl salicyl); nitromethylphenyl (i.e. —PhCH₂NO₂), trimethylsilylphenyl, t-butyldimethylsilylphenyl, vinylphenyl, vinylidenebis(phenyl), and the like. The term “a C₃-C₁₀ aromatic radical” includes substituted aromatic radicals and unsubstituted aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethy group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. Cycloaliphatic radicals may be “substituted” or “unsubstituted”. A substituted cycloaliphatic radical is defined as a cycloaliphatic radical which comprises at least one substituent. A substituted cycloaliphatic radical may comprise as many substituents as there are positions available on the cycloaliphatic radical for substitution. Substituents which may be present on a cycloaliphatic radical include but are not limited to halogen atoms such as fluorine, chlorine, bromine, and iodine. Substituted cycloaliphatic radicals include trifluoromethylcyclohexyl, hexafluoroisopropylidenebis(4-cyclohexyloxy) (i.e. —OC₆H₁₁C(CF₃)₂C₆H₁₁O—), chloromethylcyclohexyl; 3-trifluorovinyl-2-cyclopropyl; 3-trichloromethylcyclohexyl (i.e. 3—CCl₃C₆H₁₁—), bromopropylcyclohexyl (i.e. BrCH₂CH₂CH₂C₆H₁₁—), and the like. For convenience, the term “unsubstituted cycloaliphatic radical” is defined herein to encompass a wide range of functional groups. Examples of unsubstituted cycloaliphatic radicals include 4-allyloxycyclohexyl, aminocyclohexyl (i.e. H₂N C₆H₁₁—), aminocarbonylcyclopenyl (i.e. NH₂COC₅H₉—), 4-acetyloxycyclohexyl, dicyanoisopropylidenebis(4-cyclohexyloxy) (i.e. —OC₆H₁₁C(CN)₂C₆H₁₁O—), 3-methylcyclohexyl, methylenebis(4-cyclohexyloxy) (i.e. —OC₆H₁₁CH₂C₆H₁O—), ethylcyclobutyl, cyclopropylethenyl, 3-formyl-2-terahydrofuranyl, 2-hexyl-5-tetrahydrofuranyl; hexamethylene-1,6-bis(4-cyclohexyloxy) (i.e. —OC₆H₁₁(CH₂)₆ C₆H₁₁O—); 4-hydroxymethylcyclohexyl (i.e. 4-HOCH₂C₆H₁₁—), 4-mercaptomethylcyclohexyl (i.e. 4-HSCH₂C₆H₁₁—), 4-methylthiocyclohexyl (i.e. 4-CH₃SC₆H₁₁—), 4-methoxycyclohexyl, 2-methoxycarbonylcyclohexyloxy (2-CH₃OCO C₆H₁₁O—), nitromethylcyclohexyl (i.e. NO₂CH₂C₆H₁₀—), trimethylsilylcyclohexyl, t -butyldimethylsilylcyclopentyl, 4-trimethoxysilyethylcyclohexyl (e.g. (CH₃O)₃SiCH₂CH₂C₆H₁₀—), vinylcyclohexenyl, vinylidenebis(cyclohexyl), and the like. The term “a C₃-C₁₀ cycloaliphatic radical” includes substituted cycloaliphatic radicals and unsubstituted cycloaliphatic radicals containing at least three but no more than 10 carbon atoms. The cycloaliphatic radical 2-tetrahydrofuranyl (C₄H₇O—) represents a C₄-cycloaliphatic radical. The cyclohexylmethyl radical (C₆H₁₁CH₂—) represents a C₇ cycloaliphatic radical.

The present invention describes a flame retardant resin composition comprising a) a polyester, b) 0.1 weight percent to about 20 weight percent based on the total weight of the composition of a flame retardant compound, wherein said flame retardant compound comprises at least one P—H bond; c) 0.1 weight percent to about 5 weight percent based on the total weight of the composition an organic compound wherein said organic compound comprises of at least one carboxyl reactive group; and; d) 0.2 weight percent to about 20 weight percent based on the total weight of the composition of an phosphine suppressing additive compound; and wherein amount of phosphine suppression during processing or molding is greater than about 10 percentage relative to a composition comprising polyester and only component (b) or (c) of the combination.

Typically such polyester resins include crystalline polyester resins such as polyester resins derived from an aliphatic or cycloaliphatic diol, or mixtures thereof, containing from 2 to about 10 carbon atoms and at least one aromatic dicarboxylic acid. Preferred polyesters are derived from an aliphatic diol and an aromatic dicarboxylic acid and have repeating units according to structural formula (I) 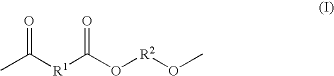
wherein, R¹ is independently at each occurrence a monovalent hydrocarbon group, aliphatic, aliphatic, or a cycloalliphatic radical and R² is independently at each occurrence comprises a mono-valent hydrocarbon group, aliphatic, aliphatic, a cycloalliphatic radical, alkenyl, allyl, or alkene radical. In one embodiment R² is an alkyl radical compromising a dehydroxylated residue derived from an aliphatic or cycloaliphatic diol, or mixtures thereof, containing from 2 to about 20 carbon atoms and R¹ is an aryl radical comprising a decarboxylated residue derived from an aromatic dicarboxylic acid. The polyester is a condensation product where R² is the residue of an aryl, alkane or cycloalkane containing diol having 6 to 20 carbon atoms or chemical equivalent thereof, and R¹ is the decarboxylated residue derived from an aryl, aliphatic or cycloalkane containing diacid of 6 to 20 carbon atoms or chemical equivalent thereof. The polyester resins are typically obtained through the condensation or ester interchange polymerization of the diol or diol equivalent component with the diacid or diacid chemical equivalent component.

The diacids meant to include carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, norbomene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, alkyl esters, e.g., dialkyl esters, diaryl esters, anhydrides, salts, acid chlorides, acid bromides, and the like. Examples of aromatic dicarboxylic acids from which the decarboxylated residue R¹ may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, e.g. 1,4-, 1,5-, or 2,6-naphthalene dicarboxylic acids. Preferred dicarboxylic acids include terephthalic acid, isophthalic acid, naphthalene dicarboxylic acids, and the like, and mixtures comprising at least one of the foregoing dicarboxylic acids.

Examples of the polyvalent carboxylic acid include, but are not limited to, an aromatic polyvalent carboxylic acid, an aromatic oxycarboxylic acid, an aliphatic dicarboxylic acid, and an alicyclic dicarboxylic acid, including terephthalic acid, isophthalic acid, ortho- phthalic acid, 1,5-naphthalenedicarboxyli acid, 2,6-naphthalenedicarboxylic acid, stibenedicarboxylic acid, diphenic acid, sulfoterephthalic acid, 5-sulfoisophthalic acid, 4-sulfophthalic acid, 4-sulfonaphthalene 2,7-dicarboxylic acid, 5-[4-sulfophenoxy] isophthalic acid, sulfoterephthalic acid, p-oxybenzoic acid, p-(hydroxyethoxy)benzoic acid, succinic acid, adipic acid, azelaic acid, sebacic acid, dodecanedicarboxylic acid, fumaric acid, maleic acid, itaconic acid, hexahydrophthalic acid, tetrahydrophthalic acid, trimellitic acid, trimesic acid, and pyrromellitic acid. These may be used in the form of metal salts and ammonium salts and the like.

Some of the diols useful in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. In one embodiment the diol include glycols, such as ethylene glycol, propylene glycol, butanediol, hydroquinone, resorcinol, trimethylene glycol, 2-methyl-1,3-propane glycol, 1,4-butanediol, hexamethylene glycol, decamethylene glycol, 1,4-cyclohexane dimethanol, or neopentylene glycol. Chemical equivalents to the diols include esters, such as dialkylesters, diaryl esters, and the like.

Examples of the polyvalent alcohol include, but are not limited to, an aliphatic polyvalent alcohol, an alicyclic polyvalent alcohol, and an aromatic polyvalent alcohol, including ethylene glycol, propylene glycol, 1,3-propanediol, 2,3-butanediol, 1,4-butanediol, 1,5-pentanediol, 1,6-hexanediol, neopentyl glycol, diethylene glycol, dipropylene glycol, 2,2,4-trimethyl-1,3-pentanediol, polyethylene glycol, polypropylene glycol, polytetramethylene glycol, trimethylolethane, trimethylolpropane, glycerin, pentaerythritol, 1,4-cyclohexanediol, 1,4-cyclohexanedimethanol, spiroglycol, tricyclodecanediol, tricyclodecanedimethanol, m-xyiene glycol, o-xylene glycol, p-xylene glycol 1,4-phenylene glycol, bisphenol A, lactone polyester and polyols. Further, with respect to the polyester resin obtained by polymerizing the polybasic carboxylic acids and the polyhydric alcohols either singly or in combination respectively, a resin obtained by capping the polar group in the end of the polymer chain using an ordinary compound capable of capping an end can also be used.

Typically the polyester resin may comprise one or more resins selected from linear polyester resins, branched polyester resins and copolymeric polyester resins. Suitable linear polyester resins include, e.g., poly(alkylene phthalate)s such as, e.g., poly(ethylene terephthalate) (“PET”), poly(butylene terephthalate) (“PBT”), poly(propylene terephthalate) (“PPT”), poly(cycloalkylene phthalate)s such as, e.g., poly(cyclohexanedimethanol terephthalate) (“PCT”), poly(alkylene naphthalate)s such as, e.g., poly(butylene-2,6-naphthalate) (“PBN”) and poly(ethylene-2,6-naphthalate) (“PEN”), poly(alkylene dicarboxylate)s such as, e.g., poly(butylene dicarboxylate).

Preferred polyesters are obtained by copolymerizing a glycol component and an acid component comprising at least about 70 mole %, preferably at least about 80 mole %, of terephthalic acid, or polyester-forming derivatives thereof. The preferred glycol, tetramethylene glycol, component can contain up to about 30 mole %, preferably up to about 20 mole % of another glycol, such as ethylene glycol, trimethylene glycol, 2-methyl-1,3-propane glycol, hexamethylene glycol, decamethylene glycol, cyclohexane dimethanol, neopentylene glycol, and the like, and mixtures comprising at least one of the foregoing glycols. The preferred acid component may contain up to about 30 mole %, preferably up to about 20 mole %, of another acid such as isophthalic acid, 2,6-naphthalene dicarboxylic acid, 2,7-naphthalene dicarboxylic acid, 1,5-naphthalene dicarboxylic acid, 4,4′-diphenyl dicarboxylic acid, 4,4′-diphenoxyethanedicarboxylic acid, sebacic acid, adipic acid, and the like, and polyester-forming derivatives thereof, and mixtures comprising at least one of the foregoing acids or acid derivatives.

Block copolyester resin components are also useful, and can be prepared by the transesterification of (a) straight or branched chain poly(alkylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. Especially useful when high melt strength is important are branched high melt viscosity resins, which include a small amount of, e.g., up to 5 mole percent based on the acid units of a branching component containing at least three ester forming groups. The branching component can be one that provides branching in the acid unit portion of the polyester, in the glycol unit portion, or it can be a hybrid branching agent that includes both acid and alcohol functionality. Illustrative of such branching components are tricarboxylic acids, such as trimesic acid, and lower alkyl esters thereof, and the like; tetracarboxylic acids, such as pyromellitic acid, and lower alkyl esters thereof, and the like; or preferably, polyols, and especially preferably, tetrols, such as pentaerythritol; triols, such as trimethylolpropane; dihydroxy carboxylic acids; and hydroxydicarboxylic acids and derivatives, such as dimethyl hydroxyterephthalate, and the like. Branched poly(alkylene terephthalate) resins and their preparation are described, for example, in U.S. Pat. No. 3,953,404 to Borman. In addition to terephthalic acid units, small amounts, e.g., from 0.5 to 15 mole percent of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexylenedimethanol, etc., as well as minor amounts of trifunctional, or higher, branching components, e.g., pentaerythritol, trimethyl trimesate, and the like.

The polyesters in one embodiment of the present invention may be a polyether ester block copolymer consisting of a thermoplastic polyester as the hard segment and a polyalkylene glycol as the soft segment. It may also be a three-component copolymer obtained from at least one dicarboxylic acid selected from: aromatic dicarboxylic acids such as terephthalic acid, isophthalic acid, phthalic acid, naphthalene-2,6-dicarboxylic acid, naphthalene-2,7-dicarboxylic acid, diphenyl-4,4-dicarboxylic acid, diphenoxyethanedicarboxylic acid or 3-sulfoisophthalic acid, alicyclic dicarboxylic acids such as 1,4-cyclohexanedicarboxylic acid, aliphatic dicarboxylic acids such as succinic acid, oxalic acid, adipic acid, sebacic acid, dodecanedicarboxylic acid or dimeric acid, and ester-forming derivatives thereof; at least one diol selected from: aliphatic diols such as 1,4-butanediol, ethylene glycol, trimethylene glycol, tetramethylene glycol, pentamethylene glycol, hexamethylene glycol, neopentyl glycol or decamethylene glycol, alicyclic diols such as 1,1-cyclohexanedimethanol, 1,4-cyclohexanedimethanol or tricyclodecanedimethanol, and ester-forming derivatives thereof; and at least one poly(alkylene oxide) glycol selected from: polyethylene glycol or poly(1,2- and 1,3-propylene oxide) glycol with an average molecular weight of about 400-5000, ethylene oxide-propylene oxide copolymer, and ethylene oxide-tetrahydrofuran copolymer.

A preferred polyester can have a number average molecular weight of about 10,000 atomic mass units (AMU) to about 200,000 AMU, as measured by gel permeation chromatography using polystyrene standards. Within this range, a number average molecular weight of at least about 20,000 AMU is preferred. Also within this range, a number average molecular weight of up to about 100,000 AMU is preferred, and a number average molecular weight of up to about 50,000 AMU is more preferred.

The polyester can be present in the composition at about 20 to about 90 weight percent, based on the total weight of the composition. Within this range, it is preferred to use at least about 25 weight percent, even more preferably at least about 35 weight percent of the polyester such as poly(butylene terephthalate). The preferred polyesters preferably have an intrinsic viscosity (as measured in 60:40 solvent mixture of phenol/tetrachloroethane at 25° C.) ranging from about 0.1 to about 1.5 deciliters per gram. Polyesters are branched or unbranched and generally have a weight average molecular weight ranging from about 5,000 to about 150,000, preferably from about 8,000 to about 95,000 as measured by viscosity measurements in Phenol/tetrachloroethane (60:40, volume/volume ratio) solvent mixture. It is contemplated that the polyesters have various known end groups.

Preferably the amount of catalyst present is less than about 200 ppm. Typically, catalyst may be present in a range from about 20 to about 300 ppm.

The flame retardant compound comprises at least one P—H bond. In one embodiment the flame retardant compound is of the formula (II): 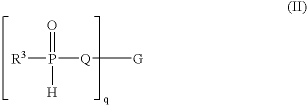
wherein R³ is at least one selected from the group consisting of a hydrogen atom, C₁-C₃₀ aliphatic, C₃-C₃₀ aromatic, a C₃-C₃₀ cycloalipohatic radical, a alkenyl, allyl, alkynyl, alkoxy, or aryloxy radical, Q is at least one selected from the group consisting of oxygen, sulfur, silicon, nitrogen, amide, or C₁-C₂₀ divalent aliphatic radical, C₃ -C₂₀ divalent aromatic radical; G is at least one selected from the group consisting of alkali metal, alkaline earth metal, boron, aluminum, transition earth metal ions, C₁-C₂₀ divalent aliphatic radical, C₃-C₂₀ divalent aromatic radical, hydroxyl, or NR⁴ where R⁴ is selected from the group consisting of a hydrogen atom, C₁-C₂₀ aliphatic, C₃-C₃₀ aromatic, a C₃-C₃₀ cycloalipohatic radical and q is an integer from 1 to 10. In one embodiment the flame retardant compound is calcium hypophosphite.

The organic compound comprising at least one carboxyl reactive group is selected from the group consisting of aliphatic or aromatic compounds. The functional group is selected from the group consisting of epoxy, carbodiimide, orthoesters, anhydrides, oxazoline, oxazoline, bisoxazolines, imidazoline and isocyanates. In a preferred embodiment the functional group is selected from the group consisting of epoxy, carbodiimide, or orthoester.

According to an embodiment, the organic compound comprising at least one carboxyl reactive group may include multifunctional epoxies. In one embodiment the stabilized composition of the present invention may optionally comprise at least one epoxy-functional polymer. One epoxy polymer is an epoxy functional (alkyl)acrylic monomer and at least one non-functional styrenic and/or (alkyl)acrylic monomer. In one embodiment, the epoxy polymer has at least one epoxy-functional (meth)acrylic monomer and at least one non-functional styrenic and/or (meth)acrylic monomer which are characterized by relatively low molecular weights. In another embodiment the epoxy functional polymer may be epoxy-functional styrene (meth)acrylic copolymers produced from monomers of at least one epoxy functional (meth)acrylic monomer and at least one non-functional styrenic and/or (meth)acrylic monomer. As used herein, the term (meth) acrylic includes both acrylic and methacrylic monomers. Non limiting examples of epoxy-functional (meth)acrylic monomers include both acrylates and methacrylates. Examples of these monomers include, but are not limited to, those containing 1,2-epoxy groups such as glycidyl acrylate and glycidyl methacrylate. Other suitable epoxy-functional monomers include allyl glycidyl ether, glycidyl ethacrylate, and glycidyl itoconate.

Epoxy functional materials suitable for use as the carboxyl reactive group contain. aliphatic or cycloaliphatic epoxy or polyepoxy functionalization. Generally, epoxy functional materials suitable for use herein are derived by the reaction of an epoxidizing agent, such as peracetic acid, and an aliphatic or cycloaliphatic point of unsaturation in a molecule. Other functionalities which will not interfere with an epoxidizing action of the epoxidizing agent may also be present in the molecule, for example, esters, ethers, hydroxy, ketones, halogens, aromatic rings, etc. A well known class of epoxy functionalized materials are glycidyl ethers of aliphatic or cycloaliphatic alcohols or aromatic phenols. The alcohols or phenols may have more than one hydroxyl group. Suitable glycidyl ethers may be produced by the reaction of, for example, monophenols or diphenols described in Formula I such as bisphenol-A with epichlorohydrin. Polymeric aliphatic epoxides might include, for example, copolymers of glycidyl methacrylate or allyl glycidyl ether with methyl methacrylate, styrene, acrylic esters or acrylonitrile.

Specifically, the epoxies that can be employed herein include glycidol, bisphenol-A diglycidyl ether, tetrabromobisphenol-A diglycidyl ether, diglycidyl ester of phthalic acid, diglycidyl ester of hexahydrophthalic acid, epoxidized soybean oil, butadiene diepoxide, tetraphenylethylene epoxide, dicyclopentadiene dioxide, vinylcyclohexene dioxide, bis(3,4-epoxy-6-methylcyclohexylmethyl) adipate, and 3,4-epoxycyclohexylmethyl-3,4-epoxycyclohexane carboxylate.

According to an embodiment, such additional carboxyl reactive groups may include reactive oxazoline compounds, which are also known as cyclic imino ether compounds. Such compounds are described in Van Benthem, Rudolfus A. T. et al., U.S. Pat. No. 6,660,869 or in Nakata, Yoshitomo et al., U.S. Pat. No. 6,100,366. Examples of such compounds are phenylene bisoxazolines, 1,3-PBO, 1,4-PBO, 1,2-naphthalene bisoxazoline, 1,8-naphthalene bisoxazoline, 1,11-dimethyl-1,3-PBO and 1,11-dimethyl-1,4-PBO.

In another embodiment, the carboxyl reactive group can be oligomeric copolymer of vinyl oxazoline and acrylic monomers. Specific examples of preferable oxazoline monomers include 2-vinyl-2-oxazoline, 5-methyl-2-vinyl-2- oxazoline, 4,4-dimethyl-2-vinyl-2-oxazoline, 4,4-dimethyl-2-vinyl-5,5- dihydro-4H-1,3-oxazoline, 2-isopropenyl-2-oxazoline, and 4,4-dimethyl-2-isopropenyl-2-oxazoline. Particularly, 2-isopropenyl-2-oxazoline and 4,4-dimethyl-2-isopropenyl-2-oxazoline are preferable, because they show good copolymerizability. The monomer component may further include other monomers copolymerizable with the cyclic imino ether group containing monomer. Examples of such other monomers include unsaturated alkyl carboxylate monomers, aromatic vinyl monomers, and vinyl cyanide monomers. These other monomers may be used either alone respectively or in combinations with each other. Examples of the unsaturated alkyl carboxylate monomer include methyl (meth)acrylate, ethyl (meth)acrylate, propyl (meth)acrylate, n-butyl (meth)acrylate, iso-butyl (meth)acrylate, t-butyl (meth)acrylate, 2-ethylhexyl (meth)acrylate, n-octyl (meth)acrylate, iso-nonyl (meth)acrylate, dodecyl (meth)acrylate, and stearyl (meth)acrylate, styrene and α-methyl styrene.

In one embodiment the organic compound comprising at least one functional group is selected from the group consisting of epoxy and orthoester. In one embodiment the organic compound comprising at least one functional group is of the formula III 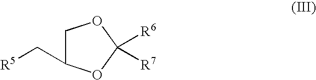
wherein R⁵, R⁶, R⁷ are independently at any occurrence an alkyl, alkoxy, aromatic, aryloxy, hydroxy, or hydrogen and with R⁶ or R⁷ is alkoxy or aryloxy or hydroxy. In yet another embodiment the organic compound containing at least one functional group is of the formula IV 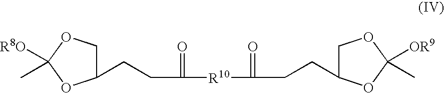
wherein R⁸, R⁹ are independently at each occurrence selected from the group consisting of alkyl, aromatic, hydrogen and R¹⁰ is an aromatic radical.

A person skilled in the art may determine the optimum amount for any given epoxy functionalized material. Generally, from about 0.1 to about 5.0 weight parts based on total weight of the composition of the epoxy functional material should be added. Preferably, from about 0.25 weight parts to about 2.0 weight parts epoxy functional material should be added.

The composition further comprises a phosphine suppressing additive compound. In one embodiment the phosphine suppressing compound comprises structural units of the formula (V) 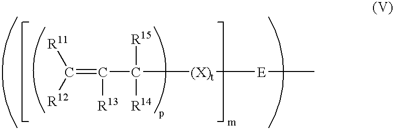
wherein R¹¹ R¹², R¹³, R¹⁴, R¹⁵, R¹⁶, R¹⁷, R¹⁸ and R¹⁹ are independently at any occurrence a hydrogen, a C₁-C₃₀ aliphatic radical, C₃-C₃₀ cycloaliphatic radical, a C₃-C₃₀ aromatic radical, alkyl, alkyne, or alkene group and X may be heteroatom like oxygen, nitrogen, sulphur, phosphorus, Si, and the like, and wherein E is a part of linear or cyclic group selected from the group consisting of a C₃-C₂₀ cycloaliphatic radical, a C₃-C₂₀ aromatic radical, a C₁-C₂₀ aliphatic radical, a sulfur-containing linkage, a phosphorus-containing linkage, an ether linkage, a carbonyl group, a tertiary nitrogen atom, and a silicon-containing linkage, m and p are whole numbers from 1 to 10 and t is 0 or 1. In one embodiment E may be part of an cyclic or acylic moiety. The cyclic moiety may comprise, carbon, oxygen, phosphorus, nitrogen and combinations thereof. In another embodiment the cyclic moiety comprises 4 to 20 atoms. In yet another embodiment the phosphine suppressing compound is at least one selected from the group consisting of triallylisocyanurate, tetraallyl terephthalamide, triallyl cyanurate, diallyl, tetrallyl, hexaallyl trimellitamide, tetraallyl/hexaallyl/octaallyl pyromellitimide, phenyl maleimide, triallyloxy phloroglucinol, hexaallyl phosphazine, 1,4-bisallyloxymethyl benzene, diallyl glycidyl isocyanurate and 1,4-bisallyloxylmethyl-2,5-dimethyl benzene. In one embodiment the phosphine suppressing additive may be in any physical form for example a liquid, a solid etc. In another embodiment the boiling point of the phosphine suppressing additive is at least greater than about 140° C. at 20 mm pressure. In another embodiment the boiling point of the phosphine suppressing additive is at least greater than about 150° C. at 10 mm pressure.

Phosphine suppressing additive having structure V are exemplified in Table 1. (dashed line (-----) signals the point of attachment of the group)

TABLE 1

| Entry | R¹¹ | R¹² | R¹³ | R¹⁴ | R¹⁵ | p | X | t | m | E | Structure |
|---|---|---|---|---|---|---|---|---|---|---|---|
| V-1 | H | H | H | H | H | 1 | — | 0 | 3 | 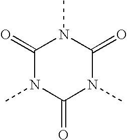 | 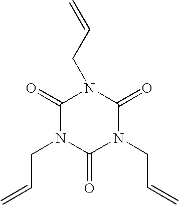 |
| V-2 | H | H | H | H | H | 1 | O | 1 | 3 | 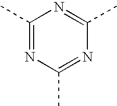 | 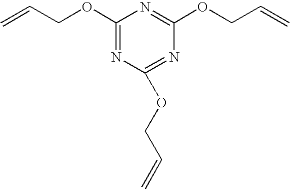 |
| V-3 | H | H | H | H | H | 2 | N | 1 | 2 | 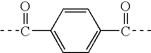 | 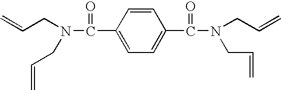 |
| V-4 | H | H | Me | H | H | 1 | O | 1 | 6 | 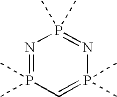 | 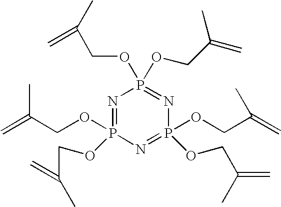 |
| V-5 | 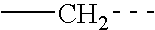 | H | H | H | H | 1 | 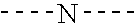 | 1 | 1 | 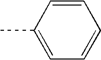 | 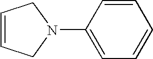 |
| V-6 | H | H | H | H | H | 1 | O | 1 | 2 | 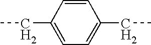 | 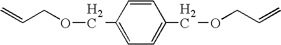 |

The ratio of reactants in the composition of the present invention is important. In one embodiment the polyester is present in a range from about 25 to about 75 mole percent. In one embodiment, the composition comprises the polyester in the range of between about 40 mole percent and about 50 mole percent. Typically, the organic compound comprising at least one carboxyl reactive compound is present in a range of between about 0.1 weight percent and about 5 weight percent based on the total weight of the composition. In another embodiment the carboxyl reactive compound is present in a range of between about 0.25 weight percent and about 2 weight percent based on the total weight of the composition. In yet another embodiment the carboxyl reactive compound is present in a range of between about 0.5 weight percent and about 1.5 weight percent based on the total weight of the composition. In one embodiment of the present invention the flame retardant is present in the range of between about 0.1 weight percent and about 20 weight percent based on the total weight of the composition. In another embodiment the flame retardant is present in the range of between about 5 weight percent and about 15 weight percent based on the total weight of the composition. In one embodiment the phosphine suppressing additive is present in the range between about 0.2 weight percent and about 20 weight percent based on the total weight of the composition. In another embodiment the phosphine suppressing additive is present in the range between about 2 weight percent and about 10 weight percent based on the total weight of the composition.

In one embodiment the polyester composition may further comprise a charring polymers such as polyetherimide, polyphenyleneoxide, polyethersulfone, polyphenylene sulfone, polyphenylene sulfide, phenol formaldehyde resins, and the like.

The polyester composition of the present invention may further comprise a nitrogen compound. The nitrogen compound used in the invention is not particularly limited as long as it is an organic or inorganic compound containing nitrogen. In one embodiment the nitrogen compound may be an optional component of the polyester composition. Non limiting representative examples of the nitrogen compound may be nitrogen-containing compounds, such as amines, amides, azo compounds, compounds having a triazine ring, salts formed by ionic bonding of a plurality of the same or difference compounds selected from the aforementioned triazine ring compounds, compounds formed through condensation of a plurality of the same or different compounds selected there from, and the like. Compounds having triazine rings may be, for example, cyanuric acid, 2-methyl-4,6-diamino-triazine, 2,4d-dimethyl-6-amino-triazine, 2-methy-4,6-dihydroxy-triazine, 2,4-dimehtyl-6-hydroxy-triazine, trimethyl triazine, tris(hydroxymethyl)triazine, tris(1 -hydroxyethyl)triazine, tris(2-hydroxyethyl)triaznne, isocyanuiic acid, tris(hydroxymethyl) isocyanurate, tris(1-hydroxyethyl)isocyanurate, tris(2-hydroxyethyl) isocyanurate, triallyl isocyanurate, and the like.

Besides, melamine and the like are also included in the nitrogen compounds. The melamine and the like refer to melamine, melamine derivatives, compounds having a similar structure to that of melamine, condensations of melamine, and the like. For example, melamine, ammeride, ammerine, benzoguanamine, acetoguanamine, formoguanamine, guanyl melamine, cyanomelamine, aryl guanamine, melam, melem, melon, succinoguanmine, adipoguanamine, rnethylglutaroguanamine, melamine phosphate, and the like. The nitrogen compound used in the invention is preferably cyanuric acid, isocyanuric acid, melamine, melamine cyanurate, melamine phosphate, melamine pyrophosphate, melamine polyphosphate and the like. In one embodiment the amount of nitrogen compound is in the range of between about 0 to about 20 weight percent based on the total weight of the composition.

In one embodiment of the present invention the thermoplastic resin composition may optionally comprise stabilizing additives. In another embodiment the stabilizing additives may be a quenchers are used in the present invention to stop the polymerization reaction. Quenchers are agents inhibit activity of any catalysts that may be present in the resins to prevent an accelerated interpolymerization and degradation of the thermoplastic. The suitability of a particular compound for use as a stabilizer and the determination of how much is to be used as a stabilizer may be readily determined by preparing a mixture of the polyester resin component and the polycarbonate and determining the effect on melt viscosity, gas generation or color stability or the formation of interpolymer. In one embodiment of the quenchers are for example of phosphorous containing compounds, boric containing acids, aliphatic or aromatic carboxylic acids i.e., organic compounds the molecule of which comprises at least one carboxy group, anhydrides, polyols.

The choice of the quencher is essential to avoid color formation and loss of clarity of the thermoplastic composition. In one embodiment of the invention, the catalyst quenchers are phosphorus containing derivatives, examples include but are not limited to diphosphites, phosphonates, metaphosphoric acid; arylphosphinic and arylphosphonic acids; polyols; carboxylic acid derivatives and combinations thereof. The amount of the quencher added to the thermoplastic composition is an amount that is effective to stabilize the thermoplastic composition. In one embodiment the amount is at least about 0.001 weight percent, preferably at least about 0.01 weight percent based on the total amounts of said thermoplastic resin compositions. The amount of quencher used is thus an amount which is effective to stabilize the composition therein but insufficient to substantially deleteriously affect substantially most of the advantageous properties of said composition.

The composition of the present invention may include additives which do not interfere with the previously mentioned desirable properties but enhance other favorable properties such as anti-oxidants, flow enhancers, reinforcing materials, colorants, mold release agents, fillers, nucleating agents, UV light and heat stabilizers, lubricants, and the like. Additionally, additives such as antioxidants, minerals such as talc, clay, mica, and other stabilizers including but not limited to UV stabilizers, such as benzotriazole, supplemental reinforcing fillers such as flaked or milled glass, and the like, flame retardants, pigments or combinations thereof may be added to the compositions of the present invention.

The compositions may, optionally, further comprise a reinforcing filler. The fillers may be of natural or synthetic, mineral or non-mineral origin, provided that the fillers have sufficient thermal resistance to maintain their solid physical structure at least at the processing temperature of the composition with which it is combined. Suitable fillers include clays, nanoclays, carbon black, wood flour either with or without oil, various forms of silica (precipitated or hydrated, fumed or pyrogenic, vitreous, fused or colloidal, including common sand), glass, metals, inorganic oxides (such as oxides of the metals in Periods 2, 3, 4, 5 and 6 of Groups Ib, IIb, IIIa, IIIb, IVa, IVb (except carbon), Va, VIa, VIIa and VIII of the Periodic Table), oxides of metals (such as aluminum oxide, titanium oxide, zirconium oxide, titanium dioxide, nanoscale titanium oxide, aluminum trihydrate, vanadium oxide, and magnesium oxide), hydroxides of aluminum or ammonium or magnesium, carbonates of alkali and alkaline earth metals (such as calcium carbonate, barium carbonate, and magnesium carbonate), antimony trioxide, calcium silicate, diatomaceous earth, fuller earth, kieselguhr, mica, talc, slate flour, volcanic ash, cotton flock, asbestos, kaolin, alkali and alkaline earth metal sulfates (such as sulfates of barium and calcium sulfate), titanium, zeolites, wollastonite, titanium boride, zinc borate, tungsten carbide, ferrites, molybdenum disulfide, asbestos, cristobalite, aluminosilicates including Vermiculite, Bentonite, montmorillonite, Na-montmorillonite, Ca-montmorillonite, hydrated sodium calcium aluminum magnesium silicate hydroxide, pyrophyllite, magnesium aluminum silicates, lithium aluminum silicates, zirconium silicates, and combinations comprising at least one of the foregoing fillers. Suitable fibrous fillers include glass fibers, basalt fibers, aramid fibers, carbon fibers, carbon nanofibers, carbon nanotubes, carbon buckyballs, ultra high molecular weight polyethylene fibers, melamine fibers, polyamide fibers, cellulose fiber, metal fibers, potassium titanate whiskers, and aluminum borate whiskers.

Alternatively, or in addition to a particulate filler, the filler may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

Optionally, the fillers may be surface modified, for example treated so as to improve the compatibility of the filler and the polymeric portions of the compositions, which facilitates deagglomeration and the uniform distribution of fillers into the polymers. One suitable surface modification is the durable attachment of a coupling agent that subsequently bonds to the polymers. Use of suitable coupling agents may also improve impact, tensile, flexural, and/or dielectric properties in plastics and elastomers; film integrity, substrate adhesion, weathering and service life in coatings; and application and tooling properties, substrate adhesion, cohesive strength, and service life in adhesives and sealants. Suitable coupling agents include silanes, titanates, zirconates, zircoaluminates, carboxylated polyolefins, chromates, chlorinated paraffins, organosilicon compounds, and reactive cellulosics. The fillers may also be partially or entirely coated with a layer of metallic material to facilitate conductivity, e.g., gold, copper, silver, and the like.

In a preferred embodiment, the reinforcing filler comprises glass fibers. For compositions ultimately employed for electrical uses, it is preferred to use fibrous glass fibers comprising lime-aluminum borosilicate glass that is relatively soda free, commonly known as “E” glass. However, other glasses are useful where electrical properties are not so important, e.g., the low soda glass commonly known as “C” glass. The glass fibers may be made by standard processes, such as by steam or air blowing, flame blowing and mechanical pulling. Preferred glass fibers for plastic reinforcement may be made by mechanical pulling. The diameter of the glass fibers is generally about 1 to about 50 micrometers, preferably about 1 to about 20 micrometers. Smaller diameter fibers are generally more expensive, and glass fibers having diameters of about 10 to about 20 micrometers presently offer a desirable balance of cost and performance. The glass fibers may be bundled into fibers and the fibers bundled in turn to yarns, ropes or rovings, or woven into mats, and the like, as is required by the particular end use of the composition. In preparing the molding compositions, it is convenient to use the filamentous glass in the form of chopped strands of about one-eighth to about 2 inches long, which usually results in filament lengths between about 0.0005 to about 0.25 inch in the molded compounds. Such glass fibers are normally supplied by the manufacturers with a surface treatment compatible with the polymer component of the composition, such as a siloxane, titanate, or polyurethane sizing, or the like.

When present in the composition, the reinforcing filler may be used at about 0 to about 60 weight percent, based on the total weight of the composition. Within this range, it is preferred to use at least about 20 weight percent of the reinforcing filler. Also within this range, it is preferred to use up to about 50 weight percent, more preferably up to about 40 weight percent, of the reinforcing filler.

Also other halogen-free flame retardants than the mentioned P or N containing compounds can be used, non limiting examples being compounds as Zn-borates, hydroxides or carbonates as Mg- and/or Al-hydroxides or carbonates, Si-based compounds like silanes or siloxanes, Sulfur based compounds as aryl sulphonates (including salts of it) or sulphoxides, Sn-compounds as stannates can be used as well often in combination with one or more of the other possible flame retardants.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert -butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl) propionic acid with mono-or polyhydric alcohols, e.g., with methanol, diethylene glycol, octadecanol, triethylene glycol, 1,6-hexanediol, pentaerythritol, neopentyl glycol, tris(hydroxyethyl) isocyanurate, thiodiethylene glycol, N,N-bis(hydroxyethyl) oxalic acid diamide. Typical, UV absorbers and light stabilizers include i) 2-(2′-hydroxyphenyl)-benzotriazoles, for example, the 5′methyl-, 3′5′-di-tert-butyl-, 5′-tert-butyl-, 5′(1,1,3,3-tetramethylbutyl)-, 5-chloro-3′,5′-di-tert-butyl-, 5-chloro-3 ′tert-butyl-5′methyl-, 3′sec-butyl-5′tert-butyl-, 4′-octoxy, 3′,5′-ditert-amyl-3′,5′-bis-(alpha, alpha-dimethylbenzyl)-derivative; ii) 2.22-Hydroxy-benzophenones, for example, the 4-hydroxy-4-methoxy-, 4-octoxy, 4-decloxy-, 4-dodecyloxy-, 4-benzyloxy, 4,2′,4′-trihydroxy-and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4-tert-butylbenzoyl)-resorcinol, benzoylresorcinol, 2,4-di-tert -butyl-phenyl-3,5-di-tert-butyl-4-hydroxybenzoate and hexadecyl-3,5-di-tert-butyl-4-hydroxybenzoate.

The composition can further comprise one or more anti-dripping agents, which prevent or retard the resin from dripping while the resin is subjected to burning conditions. Specific examples of such agents include silicone oils, silica (which also serves as a reinforcing filler), asbestos, and fibrillating-type fluorine-containing polymers. Examples of fluorine-containing polymers include fluorinated polyolefins such as, for example, poly(tetrafluoroethylene), tetrafluoroethylene/hexafluoropropylene copolymers, tetrafluoroethylene/ethylene copolymers, polyvinylidene fluoride, poly(chlorotrifluoroethylene), and the like, and mixtures comprising at least one of the foregoing anti-dripping agents. A preferred anti-dripping agent is poly(tetrafluroethylene). When used, an anti-dripping agent is present in an amount of about 0.02 to about 2 weight percent, and more preferably from about 0.05 to about 1 weight percent, based on the total weight of the composition. The flow enhancers may at least one selected from the group consisting of silicone additives, polyhydric alcohols, long chain fatty acids amides.

Dyes or pigments may be used to give a background coloration. Dyes are typically organic materials that are soluble in the resin matrix while pigments may be organic complexes or even inorganic compounds or complexes, which are typically insoluble in the resin matrix. These organic dyes and pigments include the following classes and examples: furnace carbon black, titanium oxide, zinc sulfide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

The compositions may, optionally, further comprise other conventional additives used in polyester polymer compositions such as non- reinforcing fillers, stabilizers, mold release agents, plasticizers, and processing aids. Other ingredients, such as dyes, pigments, anti-oxidants, and the like can be added for their conventionally employed purposes.

The compositions can be prepared by a number of procedures. In an exemplary process, the polyester composition, optional amorphous additives, impact modifier and filler and/or reinforcing glass is put into an extrusion compounder with resinous components to produce molding pellets. The resins and other ingredients are dispersed in a matrix of the resin in the process. In another procedure, the ingredients and any reinforcing glass are mixed with the resins by dry blending, and then fluxed on a mill and comminuted, or extruded and chopped. The composition and any optional ingredients can also be mixed and directly molded, e.g., by injection or transfer molding techniques. Preferably, all of the ingredients are freed from as much water as possible. In addition, compounding should be carried out to ensure that the residence time in the machine is short; the temperature is carefully controlled; the friction heat is utilized; and an intimate blend between the resin composition and any other ingredients is obtained.

Preferably, the ingredients are pre-compounded, pelletized, and then molded. Pre-compounding can be carried out in conventional equipment. For example, after pre-drying the polyester composition (e.g., for about four hours at about 120° C.), a single screw extruder may be fed with a dry blend of the ingredients, the screw employed having a long transition section to ensure proper melting. Alternatively, a twin screw extruder with intermeshing co-rotating screws can be fed with resin and additives at the feed port and reinforcing additives (and other additives) may be fed downstream. In either case, a generally suitable melt temperature will be about 230° C. to about 300° C. The pre-compounded composition can be extruded and cut up into molding compounds such as conventional granules, pellets, and the like by standard techniques. The composition can then be molded in any equipment conventionally used for thermoplastic compositions, such as a Newbury type injection molding machine with conventional cylinder temperatures, at about 230° C. to about 280° C., and conventional mold temperatures at about 55° C. to about 95° C. The compositions provide an excellent balance of impact strength, and flame retardancy.

The composition of the present invention can be molded into useful articles by a variety of means by many different processes to provide useful molded products such as injection, extrusion, rotation, foam molding calendar molding and blow molding and thermoforming, compaction, melt spinning form articles. The thermoplastic composition of the present invention has additional properties of good mechanical properties, color stability, oxidation resistance, good flame retardancy, good processability, i.e. short molding cycle times, thermal properties. Non limiting examples of the various articles that could be made from the thermoplastic composition of the present invention include electrical connectors, electrical devices, computers, building and construction, outdoor equipment. The articles made from the composition of the present invention may be used widely in house ware objects such as, home appliances, as well as films, electrical connectors, electrical devices, computers, building and construction, outdoor equipment, trucks and automobiles.

Typically the additive is generally present in amount corresponding to about 0 to about 1.5 weight percent based on the amount of resin. In another embodiment the additive is generally present in amount corresponding to about 0.01 to about 0.5 weight percent based on the amount of resin.

In one embodiment the polyester has an acid value of between about 5 meq/kg and about 90 meq/kg. In another embodiment the polyester has an acid value of between about 5 meq/kg and about 50 meq/kg.

The polyester composition of the present invention can be blended with conventional thermoplastics. Examples of materials suitable for use as thermoplastic material that can be blended with the polyester composition include, but are not limited to, amorphous, crystalline, and semi-crystalline thermoplastic materials such as: polyolefins (including, but not limited to, linear and cyclic polyolefins and including polyethylene, chlorinated polyethylene, polypropylene, and the like), polyesters (including, but not limited to, polyethylene terephthalate, polybutylene terephthalate, polycyclohexylmethylene terephthalate, and the like), polyamides, polysulfones (including, but not limited to, hydrogenated polysulfones, and the like), polyimides, polyether imides, polyether sulfones, polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate (PMMA), methyl methacrylate-polyimide copolymers, and the like), polyacrylonitrile, polyacetals, polycarbonates, polyphenylene ethers (including, but not limited to, those derived from 2,6-dimethylphenol and copolymers with 2,3,6-trimethylphenol, and the like), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, and tetrafluoroethylenes (e.g., Teflons) and mixtures, copolymers, reaction products, blends and composites comprising at least one of the foregoing polymers. In one embodiment, the polymer resin can be homopolymers or copolymers of one of polyolefins, polycarbonates, polyesters, polyphenylene ethers and styrenic polymers, or a mixture thereof. In another embodiment the polymer resin comprises a polyolefin selected from the group consisting of polyethylene, polypropylene, polybutylene, homopolymers, copolymers and mixtures thereof. In yet another embodiment of the present invention the polymer resin comprises polycarbonate and mixtures, copolymers, reaction products, blends and composites comprising polycarbonate.

The method of blending can be carried out by conventional techniques. The production of the compositions may utilize any of the blending operations known for the blending of thermoplastics, for example blending in a kneading machine such as a Banbury mixer or an extruder. To prepare the resin composition, the components may be mixed by any known methods. In one embodiment of the present invention the thermoplastic composition could be prepared by solution method. The solution method involves dissolving all the ingredients in a common solvent (or) a mixture of solvents preferably an organic solvent, which is substantially inert towards the polymer, and will not attack and adversely affect the polymer and either precipitation in a non-solvent or evaporating the solvent either at room temperature or a higher temperature. Some suitable organic solvents include ethylene glycol diacetate, butoxyethanol, methoxypropanol, the lower alkanols, chloroform, acetone, methylene chloride, carbon tetrachloride, tetrahydrofuran, and the like. In one embodiment of the present invention the non solvent is at least one selected from the group consisting of mono alcohols such as ethanol, methanol, isopropanol, butanols and lower alcohols with C1 to about C12 carbon atoms.

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. While only certain features of the invention have been illustrated and described herein, many modifications and changes will occur to those skilled in the art. Accordingly, these examples are not intended to limit the invention, as defined in the appended claims, in any manner.

Examples 1-3 and Comparative Examples 1 and 2: The compositions were compounded at a temperature of 250° C. in a daca Micromixer/molder. The resulting strands were cut into pellets. The amount of phosphine generated was determined by transferring the pellets to a glass tube headed at a temperature of about 300 C in an oil bath for a duration of about 15-25 minutes. The gas that evolved was mixed with nitrogen which was the carrier gas and was absorbed in potassium permanganate solution. The total amount of phosphorus absorbed in potassium permanganate solution was determined by inductively coupled plasma (ICP) method.

Examples 4 and 5 and Comparative Example 4: The compositions were compounded at a temperature in the range of about 250-270° C. on a WP25 mm co-rotating twin screw extruder, yielding a pelletized composition. Compounding was carried out at a feed rate of about 15 kilo gram per hour and a screw speed of about 300 rotations per minute. The amount of phosphine generated was determined under regular and abusive molding conditions using a Draeger Setup consisting of a pump and phosphine measuring tubes having sensitivity from 1 to 20 ppm. Under abusive conditions the polymer melt at 300° C. was kept in the machine barrel for 15 minutes and was drooled in a tray. The amount of phosphine above the tray was determined using the Draeger Tube setup.

For measuring mechanical and flammability properties of the compositions samples of standard dimensions were molded on a Demag 80 T injection molding machine in a temperature range of about 240 to 270° C. Impact strength of the samples was determined in accordance with ISO 180 standard. The tensile strength, tensile modulus and elongation at break of the compositions was determined in accordance with ISO 527 test standard. The flammability properties were determined in accordance with UL94 test protocol. Flame retardancy tests were performed following the procedure of Underwriter's Laboratory Bulletin 94 entitled “Tests for Flammability of Plastic Materials, UL94.” According to this procedure, materials may be classified as HB, V0, V1, V2, VA and/or VB on the basis of the test results obtained for five samples. In a V-series test, to achieve a rating of V0, in a sample placed so that its long axis is 180 degrees to the flame, the individual period of flaming or smoldering after removing the igniting flame does not exceed ten seconds and none of the vertically placed samples produces drips of burning particles that ignite absorbent cotton. Five bar flame out time (FOT) is the sum of the flame out time for five bars, each lit twice for a maximum flame out time of 50 seconds. To achieve a rating of V1, in a sample placed so that its long axis is 180 degrees to the flame, the individual period of flaming or smoldering after removing the igniting flame does not exceed thirty seconds and none of the vertically placed samples produces drips of burning particles that ignite absorbent cotton. Five bar flame out time is the sum of the flame out time for five bars, each lit twice for a maximum flame out time of 250 seconds. Compositions of this invention are expected to achieve a UL94 rating of V1 and/or V0 at a thickness of preferably 1.5 mm or lower.

TABLE 2
Abbreviation

| | |
|---|---|
| PBT 315 | Polybutyleneterephthalate |
| Butenediol PBT | Polybutyleneterephthalate with 10 mol % of butenediol |
| CAHPP | Calcium Hypophosphite |
| TAIC | Triallyl isocyanurate |
| ERL 4221 | Cyclohexyl epoxy |
| Na Stearate | Sodium Stearate |
| Ultem 1010 | Polyetherimide resin (GE Plastics) |

TABLE 3

| | C. Ex1 | C. Ex. 2 | C. Ex. 3 | Ex. 1 | Ex. 2 | Ex. 3 |
|---|---|---|---|---|---|---|
| PBT-315 | 70 | 65 | 69.215 | 64.215 | 59.215 | 54.215 |
| CaHPP | 30 | 30 | 30 | 30 | 30 | 30 |
| TAIC | — | 5 | — | 5 | 10 | 15 |
| ERL | — | — | 0.715 | 0.715 | 0.715 | 0.715 |
| Na Stearate | — | — | 0.07 | 0.07 | 0.07 | 0.07 |
| PH₃ Generated | 1.4 | 0.45 | 1.08 | <0.02 | <0.02 | <0.02 |
| (ppm) | | | | | | |

The Table 3 indicates that the amount of phosphine generated reduced by about 32% on addition of TAIC. Addition of ERL 4221 reduces phosphine generation by about 8%. However when a combination of TAIC and ERL 4221 more than about 98% reduction in the amount of phosphine generated is observed indicating a strong synergy between TAIC and ERL 4221 in reducing phosphine generation.

TABLE 4

| | C. Ex. 4 | Ex. 4 | Ex. 5 |
|---|---|---|---|
| PBT | 49.85 | 44.5 | 39.5 |
| CaHPP | 15 | 15 | 15 |
| Melamine Cyanurate | 10 | 10 | 10 |
| Stabilizer | 0.15 | 0.15 | 0.15 |
| TAIC | — | 5 | 5 |
| Ultem 1010 | — | — | 5 |
| ERL | — | 0.32 | 0.26 |
| Na Stearate | — | 0.02 | 0.016 |
| Glass Filler | 25 | 25 | 25 |
| Properties | | | |
| Unnotched Impact Strength (kJm⁻²) | 35.6 | 34 | 30 |
| Tensile Modulus (GPa) | 12 | 10.5 | 11 |
| Tensile Strength (MPa) | 115 | 105.5 | 103.3 |
| Elongation at break (%) | 2.43 | 2.45 | 2.3 |
| UL at 1.5 mm (rating) | V0 | V0 | V0 |
| UL at 1.0 mm (rating) | V2 | V2 | V0 |
| Phosphine (ppm) | 3 | <1 ppm | <1 ppm |

From Table 4 it is noticed that under abusive molding conditions use of TAIC and ERL 4221 in combination reduces the amount of phosphine generated by at least 66%.

From Table 4 it is also seen that the mechanical properties remain unaffected by addition of TAIC and epoxy. However an improvement in the flame property is noticed with the addition of Ultem 1010.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A flame retardant resin composition comprising:
a) a polyester;
b) 0.1 weight percent to about 30 weight percent based on the total weight of the composition of a flame retardant compound, wherein the flame retardant compound comprises at least one P—H bond
c) 0.1 weight percent to about 5 weight percent based on the total weight of the composition an organic compound wherein the organic compound comprises of at least one carboxyl reactive group; and;
d) 0.2 weight percent to about 20 weight percent based on the total weight of the composition of a phosphine suppressing additive compound;
and wherein amount of phosphine suppression during processing or molding is greater than about 10 percentage relative to a composition comprising polyester and component (b) or (c).

2. The composition of claim 1, wherein the polyester comprises structural units derived from substituted or unsubstituted diacid or diester and substituted or unsubstituted diol.

3. The composition of claim 1, wherein the diol is at least one selected from the group consisting of straight chain, branched, or cycloaliphatic alkane diols containing about 2 to 20 carbon atoms.

4. The composition of claim 1, wherein the diol is at least one selected from the group consisting of ethylene glycol; propylene glycol, butanediol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; tricyclodecane dimethanol; hydrogenated bisphenol-A, tetramethyl cyclobutane diol

5. The composition of claim 1, wherein the diacid is at least one selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, and succinic acid, or their chemical equivalents.

6. The composition of claim 1, wherein the polyester is a polyalkyleneterephthalate at least one selected from the group consisting from polybutyleneterephthalate, polyethyleneterephthalate and polypropyleneterephthalate.

7. The composition of claim 1, wherein the polyester has an acid value between about 5 and about 90 meq/kg.

8. The composition of claim 1, wherein the polyester may further comprise an olefinic or acetylinic bond.

9. The composition of claim 1, wherein the organic compound is at least one selected from the group consisting of epoxy, carbodiimide, orthoesters, anhydrides, oxazoline, and imidazolines.

10. The composition of claim 1, wherein the organic compound is present in an amount between about 0.25 weight percent and 2.0 weight percent based on the total weight of the composition.

11. The composition of claim 1, wherein the flame retardant compound is of formula (II): 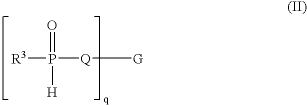
wherein R³ is at least one selected from the group consisting of a hydrogen atom, C₁-C₃₀ aliphatic, C₃-C₃₀ aromatic, a C₃-C₃₀ cycloalipohatic radical, a alkenyl, allyl, alkynyl, alkoxy, or aryloxy radical, Q is at least one selected from the group consisting of oxygen, sulfur, silicon, nitrogen, amide, or C₁-C₂₀ divalent aliphatic radical, C₃-C₂₀ divalent aromatic radical, G is at least one selected from the group consisting of alkali metal, alkaline earth metal, boron, aluminum, transition earth metal ions, C₁-C₂₀ divalent aliphatic radical, C₃-C₂₀ divalent aromatic radical, hydroxyl, or NR⁴ where R⁴ is selected from the group consisting of a hydrogen atom, C₁-C₂₀ aliphatic, C₃-C₃₀ aromatic, a C₃-C₃₀ cycloalipohatic radical and q is an integer from 1 to 10.

12. The composition of claim 1, wherein the flame retardant compound is metal salt of hypophosphorous acid, where the metal is at least one selected from the group consisting of alkali metal, alkaline earth metal, aluminum, titanium, zinc.

13. The composition of claim 1, wherein the flame retardant compound is at least one selected from the group consisting calcium hypophosphite and aluminum hypophosphite.

14. The composition of claim 1, wherein the flame retardant is present in an amount between about 5 weight percent and 15 weight percent based on the total weight of the composition.

15. The composition of claim 1, wherein the phosphine suppressing additive comprises structure units of formula (V) 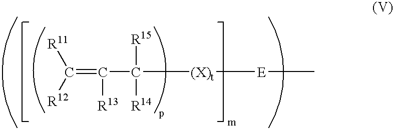
wherein R¹¹ R¹², R¹³, R¹⁴, R¹⁵, R¹⁶, R¹⁷, R¹⁸ and R¹⁹ are independently at any occurrence a hydrogen, a C₁-C₃₀ aliphatic radical, C₃-C₃₀ cycloaliphatic radical, a C₃-C₃₀ aromatic radical, alkyl, alkyne, or alkene group and X may be heteroatom like oxygen, nitrogen, sulphur, phosphorus, Si, and the like, and wherein E is a part of linear or cyclic group selected from the group consisting of a C₃-C₂₀ cycloaliphatic radical, a C₃-C₂₀ aromatic radical, a C₁-C₂₀ aliphatic radical, a sulfur-containing linkage, a phosphorus-containing linkage, an ether linkage, a carbonyl group, a tertiary nitrogen atom, and a silicon-containing linkage, m and p are whole numbers from 1 to 10 and t is 0 or 1.

16. The composition of claim 1, wherein phosphine suppressing additive is at least one selected from the group consisting of triallylisocyanurate, tetraallyl terephthalamide, triallyl isocyanurate, diallyl pyromellitimide, phenyl maleimide, triallyloxy phloroglucinol, hexaallyl phosphazine, 1,4-bisallyloxymethyl benzene, diallyl glycidyl isocyanurate and 1,4-bisallyloxylmethyl-2,5-dimethyl benzene.

17. The composition of claim 1, wherein phosphine suppressing additive is present in an amount between about 2 weight percent and 10 weight percent based on the total weight of the composition.

18. The composition of claim 1, wherein the composition may further comprise a filler, the filler is at least one selected from the group selected consisting of calcium carbonate, mica, kaolin, talc, glass fibers, carbon fibers, carbon nanotubes, magnesium carbonate, sulfates of barium, calcium sulfate, titanium, nano clay, carbon black, silica, hydroxides of aluminum or ammonium or magnesium, zirconia, nanoscale titania, or a combination comprising at least one of the foregoing fillers.

19. The composition of claim 1, wherein the filler is present in an amount between about 0 weight percent and 60 weight percent based on the total weight of the composition.

20. The composition of claim 1, wherein the composition may optionally comprise a nitrogen compound.

21. The composition of claim 20, wherein the nitrogen compound is at least one selected from the group consisting of cyanuric acid, isocyanuric acid, melamine, melamine cyanurate, melamine phosphate, melem, melamine pyrophosphate, melamine polyphosphate, melamine formaldehyde and the like.

22. The composition of claim 20, wherein the nitrogen compound is present in an amount between about 0 and about 30 weight percent based on total weight of the composition.

23. The composition of claim 1, wherein the composition may further comprise the addition of an additive.

24. The composition of claim 23, wherein the additive is selected from the group consisting of anti-oxidants, reinforcing materials, colorants, mold release agents, nucleating agents, UV light stabilizers, heat stabilizers, lubricants, antioxidants, flow enhancers, pigments or combinations thereof.

25. The composition of claim 23, wherein the additive is present in an amount between about 0 and about 5.0 weight percent based on total weight of the composition.

26. The composition of claim 1 wherein amount of phosphine suppression during processing or molding is greater than about 10 percentage relative to a composition comprising polyester and component (b) or (c).

27. The composition of claim 1, wherein the composition further comprises a charring polymer selected from the group consisting of polyetherimide, polyphenyleneoxide, polyethersulfone, polyphenylene sulfone, polyphenylene sulfide, phenol formaldehyde resins, and combinations thereof.

28. The composition of claim 1 wherein amount of phosphine suppression during processing or molding is in the range of between about 10 percent to about 99.9 percent relative to a composition comprising polyester and component (b) or (c).

29. An article comprising the composition of claim 1.

30. A flame retardant resin composition comprising:
a) a polyester, wherein the polyester is at least one selected from the group consisting from polybutyleneterephthalate, polyethyleneterephthalate and polypropyleneterephthalate;
b) 3% to about 30% of a flame retardant compound, wherein the flame retardant compound comprises at least one P—H bond, wherein the flame retardant compound is metal salt of hypophosphorous acid, where the metal is at least one selected from the group consisting of alkali metal, alkaline earth metal, aluminium, titanium, zinc;
c) 0.1% to about 3% an organic compound wherein the organic compound comprises of at least one carboxyl reactive group; wherein the organic compound is at least one selected from epoxy, carbodiimide, orthoesters, anhydrides, oxazoline and imidazoline; and;
d) 0.5% to about 15% of an phosphine suppressing additive compound, wherein the phosphine suppressing additive compound consists of at least one allyl group bonded to a C, N, O, S or P containing radical;
and wherein amount of phosphine suppression during processing or molding is greater than about 10 percentage relative to a composition comprising polyester and component (b) or (c).

31. A process to prepare a flame retardant resin composition comprising:
a) a polyester;
b) 0.1 weight percent to about 20 weight percent based on the total weight of the composition of a flame retardant compound, wherein the flame retardant compound comprises at least one P—H bond
c) 0.1 weight percent to about 5 weight percent based on the total weight of the composition an organic compound wherein the organic compound comprises of at least one carboxyl reactive group; and;
d) 0.2 weight percent to about 20 weight percent based on the total weight of the composition of an phosphine suppressing additive compound;
and wherein amount of phosphine suppression during processing or molding is greater than about 10 percentage relative to a composition comprising polyester and component (b) or (c); and wherein the process comprises:
i. mixing the polyester, flame retardant compound, organic compound, stabilizer and phosphine suppressing additive compound to form a first mixture;
ii. heating the first mixture to form the polyester composition.
